(19) United States
(12) Patent Application Publication
(10) Pub. No.: US 2026/0058690 A1
(43) Pub. Date: Feb. 26, 2026

(54) NFC EXTENSION DEVICE AND NFC EXTENSION SYSTEM

(71) Applicant: SHENZHEN ZOLON TECHNOLOGY CO., LTD., Shenzhen (CN)

(72) Inventors: XIAOJIN SUN, Shenzhen (CN); RENCHI ZHENG, Shenzhen (CN)

(21) Appl. No.: 18/901,641

(22) Filed: Sep. 30, 2024

(30) Foreign Application Priority Data
Aug. 21, 2024 (CN) 202422043099.5

(51) Int. Cl. H04B 5/43; G06K 19/07

(52) U.S. Cl. CPC H04B 5/43; G06K 19/0723

(57) ABSTRACT

A near field communication extension device and a system are disclosed in the present application. The near field communication extension device includes a first antenna structure, a second antenna structure and a transmission line, the first antenna structure includes a first impedance resonant circuit and a second impedance resonant circuit, the second antenna structure includes a third impedance resonant circuit and a fourth impedance resonant circuit, two ends of the first impedance resonant circuit are respectively connected to two ends of the third impedance resonant circuit through the first cable and the second cable, and a first end of the second cable is connected to a first connection point between the first impedance resonant circuit and the second impedance resonant circuit, and a second end of the second cable is connected to a second connection point between the third impedance resonant circuit and the fourth impedance resonant circuit.

### FIELD

The present application relates to the field of antenna technology, and in particular to a near field communication (NFC) extension device and a near field communication extension system.

### BACKGROUND

With the development of antenna technology, near field communication (NFC) has been more widely used, an NFC card reader device need to be closer to a contactless card in order to complete the reading of card information. As a result, the reading area of the card reader device is very small and inconvenient to operate.

Therefore, improvement is desired.

### SUMMARY OF THE INVENTION

In a first aspect, the embodiments of the present application provide a near field communication (NFC) extension device and a near field communication extension system. The present application can extend the card reading recognition area of a card reader device and can overcome the limitations of installing card reader device in areas where thick wooden boards, glass, or metal blocks the card reading area, making it difficult to read cards smoothly, which is practical and convenient.

In a first aspect, the present application provides an NFC extension device, the NFC extension device includes a first antenna structure, a second antenna structure and a transmission line electrically connected between the first antenna structure and the second antenna structure; the first antenna structure is configured to couple with a card reading device to receive a card reading command signal and to transmit the card reading command signal to the second antenna structure through the transmission line; and the second antenna structure is configured to couple with a contactless card for transmitting the card reading command signal into the contactless card; wherein the first antenna structure comprises a first impedance resonant circuit and a second impedance resonant circuit, the second antenna structure comprises a third impedance resonant circuit and a fourth impedance resonant circuit, the transmission line comprises a first cable and a second cable, two ends of the first impedance resonant circuit are respectively electrically connected to two ends of the third impedance resonant circuit through the first cable and the second cable, and a first end of the second cable is electrically connected to a first connection point between the first impedance resonant circuit and the second impedance resonant circuit, and a second end of the second cable is electrically connected to a second connection point between the third impedance resonant circuit and the fourth impedance resonant circuit.

In some optional embodiments, the first antenna structure further includes a first coil, a first end the first coil is electrically connected to the first cable and one end of the first impedance resonant circuit, and a second end of the first coil is electrically connected to one end of the second impedance resonant circuit.

In some optional embodiments, the first antenna structure further includes a first matching resistor, the first matching resistor is electrically connected between the second end of the first coil and one end of the second impedance resonant circuit.

In some optional embodiments, the second antenna structure further includes a second coil, a first end of the second coil is electrically connected to the first cable and one end of the third impedance resonant circuit, and a second end of the second coil is electrically connected to one end of the fourth impedance resonant circuit.

In some optional embodiments, the second antenna structure further includes a second matching resistor, the second matching resistor is electrically connected between the second end of the second coil and one end of the fourth impedance resonant circuit.

In some optional embodiments, an output impedance of the first antenna structure is equal to a characteristic impedance of the transmission line.

In some optional embodiments, the second antenna structure is configured to receive a card information signal output by the contactless card, and transmit the card information signal to the first antenna structure through the transmission line; and the first antenna structure is configured to transmit the card information signal to the card reading device.

In some optional embodiments, the first cable and the second cable are both coaxial cables.

In some optional embodiments, the first impedance resonant circuit includes a first capacitor, the second impedance resonant circuit includes a second capacitor, the third impedance resonant circuit includes a third capacitor, and the fourth impedance resonant circuit includes a fourth capacitor.

In a second aspect, the present application provides an NFC extension system, the NFC extension system includes a card reading device and an NFC extension device, the NFC extension device is coupled to the card reading device, and the card reading device is configured to transmit a card reading command signal to a contactless card through the NFC extension device and receive a card information signal from the contactless card through the NFC extension device.

### BRIEF DESCRIPTION OF THE DRAWINGS

FIG. 1 is a schematic diagram of a near field communication extension system according to an embodiment of the present application.

FIG. 2 is a schematic diagram of a near field communication extension device according to an embodiment of the present application.

FIG. 3 is another schematic diagram of the NFC extension device according to an embodiment of the present application.

FIG. 4 is a circuit diagram of the NFC extension device according to an embodiment of the present application.

FIG. 5 shows a diagram of an application scenario of the NFC extension device according to the present application.

### DETAILED DESCRIPTION OF THE INVENTION

The technical solutions in the embodiments of the present application will be clearly described below in conjunction with the accompanying drawings in the embodiments of the present application.

The connection relationship described in the present application refers to a direct connection or indirect connection. For example, A is connected to B, either directly from A to B or indirectly from A to B via one or more other electrical components. For example, A is directly connected to C, and C is directly connected to B, so that the connection between A and B is realized through C. The “A connected to B” described in the present application can be a direct connection between A and B, or an indirect connection between A and B through one or more other electrical components.

In the description of the present application, unless otherwise indicated, “/” means “or”, for example, A/B may be denoted as A or B, in the present application, “and/or” is merely a description of an associated relationship of an associated object, indicating that three kinds of relationships may exist, for example, A and/or B can represent three situations: A exists alone, A and B exist simultaneously, and B exists alone.

In the description of the present application, the terms “first”, “second” are used only to distinguish between different objects and do not qualify the number and order of execution.

With the development of antenna technology, near field communication (NFC) has been more widely used, an NFC card reader device need to be closer to a contactless card in order to complete the reading of card information. As a result, the reading area of the card reader device is very small and inconvenient to operate.

For example, in a scenario where the card reader device must be mounted behind an obstacle such as a thick wooden board, double glazing, a metal spacer magnetic material, etc., the isolation setup of the obstacle makes the reading area of the card reader device farther away from the contactless card, or the obstacle may reduce the strength of the electromagnetic signals between the card reader device and the contactless card, which results in a possible failure of the card reader device to read the card, making the user experience poor.

For example, in a scenario where the card reader device is a POS machine of a merchant and the contactless card is a bank card, in order to meet the security requirements, the cashier staff of the merchant must maintain a certain distance from the customer who pays, so the cashier staff of the merchant need to pass the POS machine far closer to the customer in order to read the information on the bank card and complete the collection of money, so frequent and tiring actions also make the merchant staff have poor flexibility and poor experience.

Therefore, the present application provides an NFC extension device and an NFC extension system that can extend the card reading recognition area of a card reader device and can overcome the limitations of installing card reader device in areas where thick wooden boards, glass, or metal blocks the card reading area, making it difficult to read cards smoothly, which is practical and convenient.

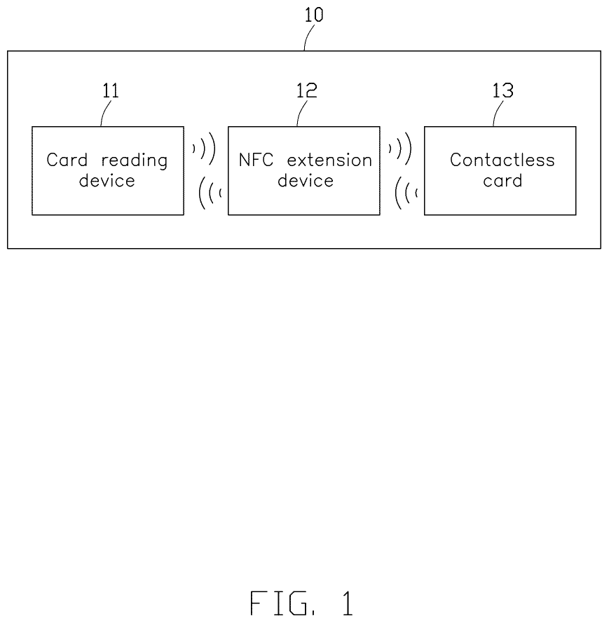

FIG. 1 illustrates a near field communication (NFC) extension system 10 in accordance with an embodiment of the present application.

The 10 includes a card reading device 11, a near field communication (NFC) extension device 12, and a contactless card 13.

The card reading device 11 is used to transmit a card reading command signal to the contactless card 13 through the NFC extension device 12, the card reading device 11 is used to receive a card information signal from the contactless card 13 through the NFC extension device 12. After the card reading device 11 transmits a card reading command signal to the contactless card 13 through the NFC extension device 12, the contactless card 13 can feedback a card information signal including card information such as a card number based on the card reading command signal, and transmit the card information signal to the card reading device 11 through the NFC extension device 12.

In some embodiments, the card reading device 11 can be a POS machine, an NFC card reader, an access card reader, or a terminal device with NFC card reading function. The contactless card 13 can be a physical card such as a bank card, an NFC electronic tag, an access card, a contactless integrated circuit card, a bus card, the contactless card 13 can also be a terminal device with NFC simulation function.

Therefore, the NFC extension device 12 is provided between the card reading device 11 and the contactless card 13, which can effectively extend the card reading range of the card reading device 11 and enhance the user's experience of reading or tapping the card.

The following specifies the composition and working principle of the NFC extension device 12.

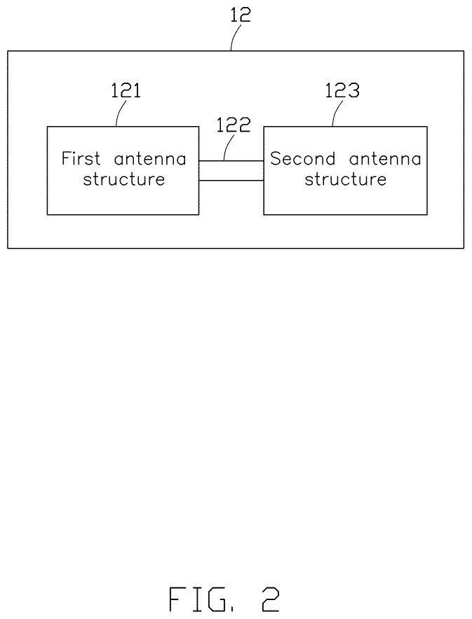

FIG. 2 illustrates the NFC extension device 12 in accordance with an embodiment of the present application.

The NFC extension device 12 includes a first antenna structure 121, a transmission line 122, and a second antenna structure 123. The first antenna structure 121 is electrically connected to the second antenna structure 123 through the transmission line 122.

The first antenna structure 121 is used to couple with the card reading device 11 to receive the card reading command signal and transmit the card reading command signal to the second antenna structure 123 through the transmission line 122. More specifically, the first antenna structure 121 includes a coil, and the coil of the first antenna structure 121 is coupled with a built-in coil of the card reading device 11, so as to receive the card reading command signal output from the output coil of the card reading device 11 based on the principle of electromagnetic induction. The card reading command signal can be transmitted to the second antenna structure 123 through the transmission line 122.

The second antenna structure 123 is used to couple with the contactless card 13 to transmit the card reading command signal into the contactless card 13. More specifically, the second antenna structure 123 includes a coil, and the coil of the second antenna structure 123 is coupled with a built-in coil of the contactless card 13, so that the card reading command signal can be coupled into the built-in coil of the contactless card 13 based on the principle of electromagnetic induction.

The second antenna structure 123 is used to receive the card information signal outputted by the contactless card 13 and transmit the card information signal to the first antenna structure 121 through the transmission line 122. More specifically, when the contactless card 13 receives the card reading command signal, the contactless card 13 will output a corresponding card information signal based on the card reading command signal and the card information signal can be coupled into the coil of the second antenna structure 123 through the built-in coil of the contactless card 13. Therefore, the second antenna structure 123 can receive the card information signal and transmit the card information signal to the first antenna structure 121 through the transmission line 122.

The first antenna structure 121 is used to transmit the card information signal to the card reading device 11. More specifically, the first antenna structure 121 receives the card information signal, and then couples and transmits the card information signal to the built-in coil of the card reading device 11 through the coil of the first antenna structure 121, so that the card reading device 11 can receive the card information signal and complete the card reading process.

In some embodiments, the components and the connection methods of the first antenna structure 121 and the second antenna structure 123 can be the same, which can reduce the configuration cost of the NFC extension device 12. In some other embodiments, the components and the connection methods of the first antenna structure 121 and the transmission line 122 can also be configured to be different according to the actual needs, so as to improve the compatible adaptability of the NFC extension device 12.

In some embodiments, the transmission line 122 can be a coaxial cable, which can reduce signal transmission losses and improve signal transmission confidentiality.

The present application can couple the card reading command signal output by the card reading device 11 to the built-in coil of the contactless card 13 through the first antenna structure 121, the transmission line 122, and the second antenna structure 123 by setting the first antenna structure 121, the transmission line 122, and the second antenna structure 123, and can transmit the card information signal of the contactless card 13 back to the card reading device 11 through the second antenna structure 123, the transmission line 122, and the first antenna structure 121. Therefore, the NFC extension device 12 can effectively expand the communication distance between the card reading device 11 and the contactless card 13.

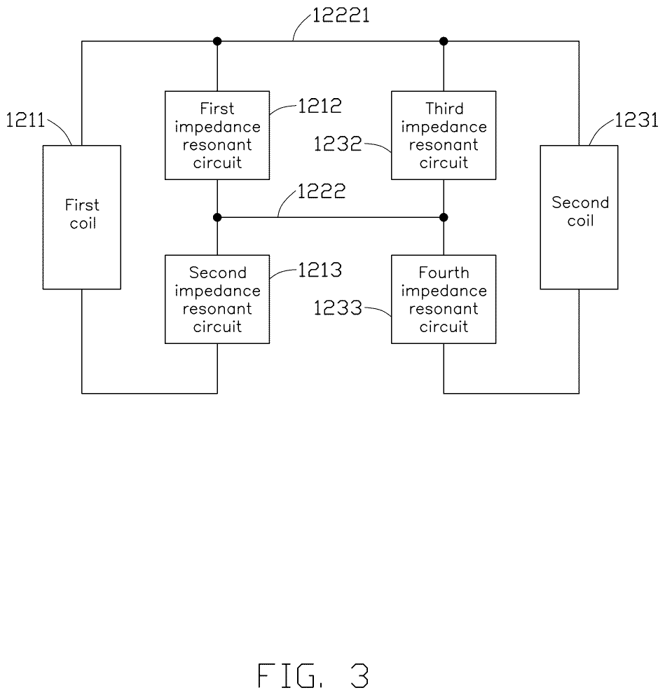

FIG. 3 illustrates the NFC extension device 12 in accordance with another embodiment of the present application.

The first antenna structure 121 includes a first coil 1211, a first impedance resonant circuit 1212, and a second impedance resonant circuit 1213. The transmission line 122 includes a first cable 1221 and a second cable 1222. The second antenna structure 123 includes a second coil 1231, a third impedance resonant circuit 1232, and a fourth impedance resonant circuit 1233.

The first coil 1211, the first impedance resonant circuit 1212, and the second impedance resonant circuit 1213 constitute the first antenna structure 121, and the second coil 1231, the third impedance resonant circuit 1232, and the fourth impedance resonant circuit 1233 constitute the second antenna structure 123.

Two ends of the first impedance resonant circuit 1212 are respectively electrically connected to two ends of the third impedance resonant circuit 1232 through the first cable 1221 and the second cable 1222. One end of the second cable 1222 is electrically connected to a connection point between the first impedance resonant circuit 1212 and the second impedance resonant circuit 1213, and another end of the second cable 1222 is electrically connected to a connection point between the third impedance resonant circuit 1232 and the fourth impedance resonant circuit 1233.

The first impedance resonant circuit 1212 and the second impedance resonant circuit 1213 can include one or more capacitors, multiple capacitors can be connected in series, parallel, or mixed with each other. Similarly, the third impedance resonant circuit 1232 and the fourth impedance resonant circuit 1233 can also include one or more capacitors, multiple capacitors can be connected in series, parallel, or mixed with each other.

Therefore, the first coil 1211, the first impedance resonant circuit 1212, and the second impedance resonant circuit 1213 form an RC resonance loop, and the resonance frequency is determined by the equivalent inductance of the first coil 1211, the equivalent capacitance of the first impedance resonant circuit 1212 and the equivalent capacitance of the second impedance resonant circuit 1213. The output impedance of the first antenna structure 121 is also determined by the equivalent inductance of the first coil 1211, the equivalent capacitance of the first impedance resonant circuit 1212 and the equivalent capacitance of the second impedance resonant circuit 1213.

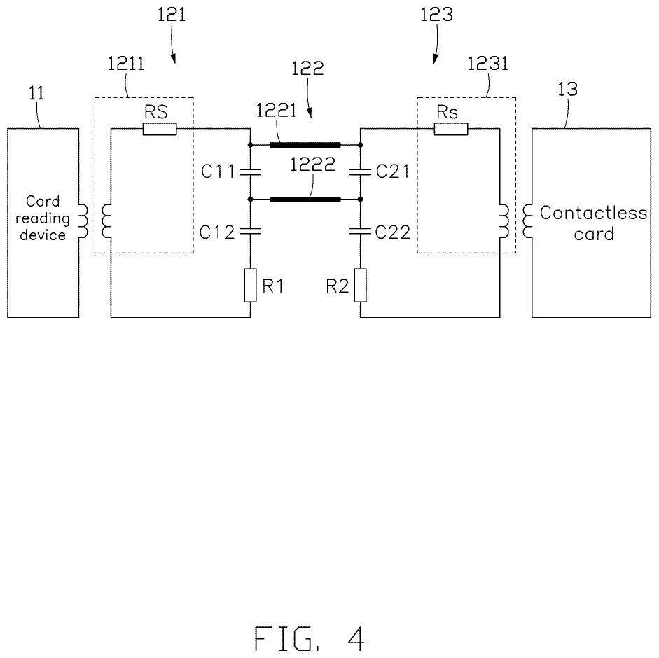

Referring to FIG. 4, FIG. 4 is a circuit diagram of the NFC extension device 12 according to an embodiment of the present application.

The first impedance resonant circuit 1212 includes a capacitor C11, the second impedance resonant circuit 1213 includes a capacitor C12, the third impedance resonant circuit 1232 includes a capacitor C21, and the fourth impedance resonant circuit 1233 includes a capacitor C22. The first coil 1211 can be equivalent to a series connection of the first coil inductance and equivalent resistance RS, and the second coil 1231 can be equivalent to a series connection of the second coil inductance and equivalent resistance RS.

The first antenna structure 121 further includes a resistor R1, and the second antenna structure 123 further includes a resistor R2. Two ends of the resistor R1 are respectively electrically connected to one end of the capacitor C12 and one end of the first coil 1211, two ends of the resistor R2 are respectively electrically connected to one end of the capacitor C22 and one end of the second coil 1231.

The resistor R1 and the resistor R2 are respectively used to adjust the Q value of the first antenna structure 121 and the Q value of the second antenna structure 123. In some embodiments, the resistor R1 and the resistor R2 can be omitted.

More specifically, the output impedance of the first antenna structure 121 can be obtained by the following formula (1):

$${Z}_{11} = \frac{{C}_{12}^{2} \times {( 2 π {f}_{0} L )}^{2}}{[ {( {C}_{11} + {C}_{12} )}^{2} \times ( {R}_{s} + {R}_{t} + {R}_{1} ) ]} \qquad formula ( 1 )$$

f₀ is the resonance frequency, L is the equivalent inductance of the first coil 1211, C₁₁ is the capacitance value of the capacitor C11, C₁₂ is the capacitance value of the capacitor C12, Rₛ is the loss resistance of the first antenna structure 121, Rₜ is the radiation resistance of the first antenna structure 121, R₁ is the sum of the resistance value of the resistor R1 and the equivalent resistance value of the series capacitance of the capacitor C11 and the capacitor C12.

Therefore, according to formula (1), the output impedance of the first antenna structure 121 is correlated with the resonance frequency of the first antenna structure 121. Due to the fact that the resonance frequency of the NFC antenna structures is mostly a preset fixed value, such as contactless card 13.56 MHz, it is necessary to adjust the output impedance of the first antenna structure 121 according to a fixed resonance frequency, so that the output impedance of the first antenna structure 121 matches the characteristic impedance of the transmission line 122, in order to reduce the transmission loss of signals on the transmission line.

Compared to setting a single impedance resonant circuit that is more difficult to simultaneously satisfy a specific resonance frequency and a specific output impedance, the present application can make two impedance resonant circuits constitute a capacitance divider structure by setting two impedance resonant circuits that are set between the two transmission cables and on a side, the resonance frequency and the output impedance of the first antenna structure 121 can be adaptively adjusted by flexibly adjusting the number, capacitance value, connection relationship of the capacitors in the first impedance resonant circuit 1212 and the second impedance resonant circuit 1213, or by flexibly adjusting the ratio between the equivalent capacitance of the first impedance resonant circuit 1212 and the second impedance resonant circuit 1213, therefore, it can be adapted to multiple structures of the first coil 1211, facilitating the diversified design of the first coil 1211 and making it easier to simultaneously meet specific resonance frequencies and specific output impedances. In addition, the first impedance resonant circuit 1212 and the second impedance resonant circuit 1213 can be used to form a resonance frequency and achieve impedance matching between the first antenna structure 121 and the transmission line 122, this can simplify the matching circuit and reduce the overall insertion loss of the NFC extension device 12.

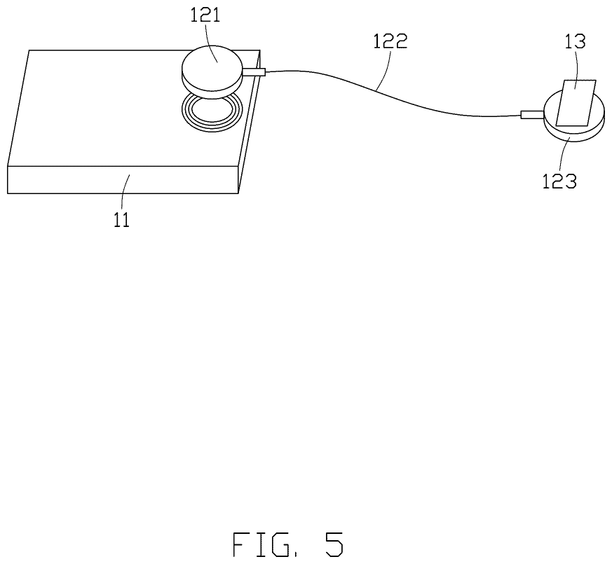

Referring to FIG. 5, when the NFC extension device 12 operates normally, the card reading device 11 outputs a card reading command signal, and the card reading command signal manifests itself as an alternating electromagnetic wave signal. The first coil 1211 of the first antenna structure 121 is coupled to the card reading device 11, and thus, based on the principle of electromagnetic induction, the card reading command signal can be received and an induced voltage can be generated between the first cable 1221 and the second cable 1222, thereby forming a current loop between the first antenna structure 121, the transmission line 122, and the second antenna structure 123. Since the current flowing in the first antenna structure 121 is equal to the current flowing in the second antenna structure 123, the second coil 1231 of the second antenna structure 123 radiates an alternating electromagnetic wave signal that is the same as the card reading command signal. Thereby, the NFC extension device 12 can realize the extension of the card reading area of the card reading device 11.

The above embodiments are only used to illustrate the technical solution of the present application, and not to limit it; although the present application has been described in detail with reference to the aforementioned embodiments, ordinary technical personnel in this field should understand; it can still modify the technical solutions recorded in the aforementioned embodiments, or equivalently replace some of the technical features; and these modifications or replacements do not separate the essence of the corresponding technical solutions from the spirit and scope of the technical solutions in each embodiment of the present application, and should be included in the scope of protection of the present application.

What is claimed is:

1. A near field communication (NFC) extension device comprising a first antenna structure, a second antenna structure and a transmission line electrically connected between the first antenna structure and the second antenna structure;
the first antenna structure configured to couple with a card reading device to receive a card reading command signal and to transmit the card reading command signal to the second antenna structure through the transmission line; and
the second antenna structure configured to couple with a contactless card for transmitting the card reading command signal into the contactless card;
wherein the first antenna structure comprises a first impedance resonant circuit and a second impedance resonant circuit, the second antenna structure comprises a third impedance resonant circuit and a fourth impedance resonant circuit, the transmission line comprises a first cable and a second cable, two ends of the first impedance resonant circuit are respectively electrically connected to two ends of the third impedance resonant circuit through the first cable and the second cable, and a first end of the second cable is electrically connected to a first connection point between the first impedance resonant circuit and the second impedance resonant circuit, and a second end of the second cable is electrically connected to a second connection point between the third impedance resonant circuit and the fourth impedance resonant circuit.

2. The NFC extension device of claim 1, wherein the first antenna structure further comprises a first coil, a first end the first coil is electrically connected to the first cable and one end of the first impedance resonant circuit, and a second end of the first coil is electrically connected to one end of the second impedance resonant circuit.

3. The NFC extension device of claim 1, wherein the first antenna structure further comprises a first matching resistor, the first matching resistor is electrically connected between the second end of the first coil and one end of the second impedance resonant circuit.

4. The NFC extension device of claim 1, wherein the second antenna structure further comprises a second coil, a first end of the second coil is electrically connected to the first cable and one end of the third impedance resonant circuit, and a second end of the second coil is electrically connected to one end of the fourth impedance resonant circuit.

5. The NFC extension device of claim 1, wherein the second antenna structure further comprises a second matching resistor, the second matching resistor is electrically connected between the second end of the second coil and one end of the fourth impedance resonant circuit.

6. The NFC extension device of claim 1, wherein an output impedance of the first antenna structure is equal to a characteristic impedance of the transmission line.

7. The NFC extension device of claim 1, wherein the second antenna structure is configured to receive a card information signal output by the contactless card, and transmit the card information signal to the first antenna structure through the transmission line; and the first antenna structure is configured to transmit the card information signal to the card reading device.

8. The NFC extension device of claim 1, wherein the first cable and the second cable are both coaxial cables.

9. The NFC extension device of claim 1, wherein the first impedance resonant circuit comprises a first capacitor, the second impedance resonant circuit comprises a second capacitor, the third impedance resonant circuit comprises a third capacitor, and the fourth impedance resonant circuit comprises a fourth capacitor.

10. A near field communication (NFC) extension system comprising a card reading device and an NFC extension device, the NFC extension device coupled to the card reading device, and the card reading device configured to transmit a card reading command signal to a contactless card through the NFC extension device and receive a card information signal from the contactless card through the NFC extension device, the NFC extension device comprising a first antenna structure, a second antenna structure and a transmission line electrically connected between the first antenna structure and the second antenna structure;
the first antenna structure configured to couple with a card reading device to receive a card reading command signal and to transmit the card reading command signal to the second antenna structure through the transmission line; and
the second antenna structure configured to couple with a contactless card for transmitting the card reading command signal into the contactless card;
wherein the first antenna structure comprises a first impedance resonant circuit and a second impedance resonant circuit, the second antenna structure comprises a third impedance resonant circuit and a fourth impedance resonant circuit, the transmission line comprises a first cable and a second cable, two ends of the first impedance resonant circuit are respectively electrically connected to two ends of the third impedance resonant circuit through the first cable and the second cable, and a first end of the second cable is electrically connected to a first connection point between the first impedance resonant circuit and the second impedance resonant circuit, and a second end of the second cable is electrically connected to a second connection point between the third impedance resonant circuit and the fourth impedance resonant circuit.

11. The NFC extension system of claim 10, wherein the first antenna structure further comprises a first coil, a first end the first coil is electrically connected to the first cable and one end of the first impedance resonant circuit, and a second end of the first coil is electrically connected to one end of the second impedance resonant circuit.

12. The NFC extension system of claim 10, wherein the first antenna structure further comprises a first matching resistor, the first matching resistor is electrically connected between the second end of the first coil and one end of the second impedance resonant circuit.

13. The NFC extension system of claim 10, wherein the second antenna structure further comprises a second coil, a first end of the second coil is electrically connected to the first cable and one end of the third impedance resonant circuit, and a second end of the second coil is electrically connected to one end of the fourth impedance resonant circuit.

14. The NFC extension system of claim 10, wherein the second antenna structure further comprises a second matching resistor, the second matching resistor is electrically connected between the second end of the second coil and one end of the fourth impedance resonant circuit.

15. The NFC extension system of claim 10, wherein an output impedance of the first antenna structure is equal to a characteristic impedance of the transmission line.

16. The NFC extension system of claim 10, wherein the second antenna structure is configured to receive a card information signal output by the contactless card, and transmit the card information signal to the first antenna structure through the transmission line; and the first antenna structure is configured to transmit the card information signal to the card reading device.

17. The NFC extension system of claim 10, wherein the first cable and the second cable are both coaxial cables.

18. The NFC extension system of claim 10, wherein the first impedance resonant circuit comprises a first capacitor, the second impedance resonant circuit comprises a second capacitor, the third impedance resonant circuit comprises a third capacitor, and the fourth impedance resonant circuit comprises a fourth capacitor.
